(19) United States
(12) Patent Application Publication
(10) Pub. No.: US 2018/0005445 A1
(43) Pub. Date: Jan. 4, 2018

(54) Augmenting a Moveable Entity with a Hologram

(71) Applicant: Microsoft Technology Licensing, LLC, Redmond, WA (US)

(72) Inventors: Daniel Joseph McCulloch, Snohomish, WA (US); Nicholas Gervase Fajt, Seattle, WA (US); Adam G. Poulos, Sammamish, WA (US); Christopher Douglas Edmonds, Carnation, WA (US); Lev Cherkashin, Redmond, WA (US); Brent Charles Allen, Kirkland, WA (US); Constantin Dulu, Redmond, WA (US); Muhammad Jabir Kapasi, Sammamish, WA (US); Michael Grabner, Seattle, WA (US); Michael Edward Samples, Redmond, WA (US); Cecilia Bong, Sammamish, WA (US); Miguel Angel Susffalich, Kirkland, WA (US); Varun Ramesh Mani, Redmond, WA (US); Anthony James Ambrus, Seattle, WA (US); Arthur C. Tomlin, Kirkland, WA (US); James Gerard Dack, Seattle, WA (US); Jeffrey Alan Kohler, Redmond, WA (US); Eric S. Rehmeyer, Kirkland, WA (US); Edward D. Parker, Kirkland, WA (US)

(73) Assignee: Microsoft Technology Licensing, LLC, Redmond, WA (US)

(21) Appl. No.: 15/199,831

(22) Filed: Jun. 30, 2016

(51) Int. Cl. G06T 19/00; G03H 1/00; G06F 3/01

(52) U.S. Cl. CPC G06T 19/006; G06F 3/011; G03H 1/0005; G06T 2207/30241; G06T 2207/30196

(57) ABSTRACT

In embodiments of augmenting a moveable entity with a hologram, an alternate reality device includes a tracking system that can recognize an entity in an environment and track movement of the entity in the environment. The alternate reality device can also include a detection algorithm implemented to identify the entity recognized by the tracking system based on identifiable characteristics of the entity. A hologram positioning application is implemented to receive motion data from the tracking system, receive entity characteristic data from the detection algorithm, and determine a position and an orientation of the entity in the environment based on the motion data and the entity characteristic data. The hologram positioning application can then generate a hologram that appears associated with the entity as the entity moves in the environment.

### BACKGROUND

Virtual reality and augmented reality systems and devices are increasingly popular, particularly for gaming applications in which a user can immerse him or herself into the gaming environment when wearing a head-mounted display unit that displays virtual and/or augmented reality user experiences. Some conventional alternate reality systems (e.g., virtual and/or augmented reality systems) are marker-based systems, some relying on external markers to track the motion of a device, while others rely on externally positioned cameras that provide feedback images from which the motion of the device in the systems can be tracked. For example, an alternate reality system may include a head-mounted display unit and an external input device. To accurately track the external input device in relation to the head-mounted display unit, external cameras positioned in the three-dimensional (3D) space in which the external input device is used track the motion of the input device for correlation with the head-mounted display unit. A head-mounted display unit of an alternate reality system can also generate holograms for viewing by a person who is wearing the head mounted display unit. However, conventional systems can only generate a hologram that appears as a static image, rigidly docked to a particular surface or stationary controller in the 3D space.

### SUMMARY

This Summary introduces features and concepts of augmenting a moveable entity with a hologram, which is further described below in the Detailed Description and/or shown in the Figures. This Summary should not be considered to describe essential features of the claimed subject matter, nor used to determine or limit the scope of the claimed subject matter.

Augmenting a moveable entity with a hologram is described. In embodiments, an alternate reality device includes a tracking system that can recognize an entity in an environment and track movement of the entity in the environment, such as in three-dimensional (3D) space. The alternate reality device can also include a detection algorithm implemented to identify the entity recognized by the tracking system based on identifiable characteristics of the entity. A hologram positioning application is implemented to receive motion data from the tracking system, receive entity characteristic data from the detection algorithm, and determine a position and an orientation of the entity in the environment based on the motion data and the entity characteristic data. The hologram positioning application can then generate a hologram that appears associated with the entity as the entity moves in the environment.

In other aspects of augmenting a moveable entity with a hologram, the detection algorithm in the alternate reality device can be implemented as a neural network to identify the entity in the environment, where the neural network includes an entity specific recognizer based on the identifiable characteristics of the entity. The tracking system of the alternate reality device can recognize and track a feature of a person, such as an arm, hand, fingers, head, the entire person, and the like. The tracking system can include skeletal tracking to track the movement of the feature of the person in the environment. Alternatively or in addition, the tracking system can include motion sensing to track the movement of the feature of the person in the environment. The person, or feature of the person, may be the person using the alternate reality device, or can be a different person in the environment. The hologram positioning application can generate a hologram that appears as a wearable item being worn by the person.

In other aspects of augmenting a moveable entity with a hologram, the entity being tracked may be an object capable of being moved in the environment, such as a chair or other type of object that is movable by a person. The hologram positioning application can generate a hologram that appears attached to or placed on the object and remains associated with the object as the object moves in the environment. Similarly, the entity being tracked may be an entity that moves dynamically in the environment, such as a person or a dog that may move in any direction at any time in the environment. The hologram positioning application can generate a hologram that appears attached to or placed on the entity and remains associated with the entity as the entity moves in the environment. Further, holograms can be pinned or docked to meaningful locations on or within an entity, such as on the tail of a dog as the dog moves about in the environment.

### BRIEF DESCRIPTION OF THE DRAWINGS

Embodiments of augmenting a moveable entity with a hologram are described with reference to the following Figures. The same numbers may be used throughout to reference like features and components that are shown in the Figures:

FIG. 1 illustrates an example alternate reality device in accordance with one or more embodiments.

FIG. 2 illustrates an example of augmenting a moveable entity with a hologram in an environment.

FIG. 3 illustrates an example method of augmenting a moveable entity with a hologram in accordance with one or more embodiments.

FIG. 4 illustrates an example camera-based input device in accordance with one or more embodiments.

FIG. 5 illustrates an example system in which embodiments of augmenting a moveable entity with a hologram can be implemented.

FIG. 6 illustrates an example system with an example device that can implement embodiments of augmenting a moveable entity with a hologram.

### DETAILED DESCRIPTION

Embodiments of augmenting a moveable entity with a hologram are described. A person can wear a head-mounted display unit to immerse him or herself in a virtual and/or augmented reality environment. Generally, the term “alternate reality” is used herein to refer to devices and systems that are implemented for virtual reality and/or augmented reality, such as for mixed reality devices. A head-mounted display unit is an alternate reality device that can be worn by a user and implemented with various systems and sensors to recognize an entity that is moving or movable in an environment, identify the entity that has been recognized based on identifiable characteristics of the entity, determine a position and an orientation of the entity in the environment, and generate a hologram that appears associated with the entity as the entity moves in the environment.

In implementations, the alternate reality device (e.g., a head-mounted display unit) has a tracking system that can recognize an entity and track movement of the entity in the environment, such as in three-dimensional (3D) indoor or outdoor space. The tracking system can recognize the entity in the environment as a person or features of the person (e.g., an arm, hand, head, etc.), an animal (e.g., a dog or cat), or an object, such as a chair, a table, or other item that may be moved by a person. The tracking system can include skeletal tracking to track the movement of a person or a feature of the person in the environment, where the person or feature of the person, may be the person using the alternate reality device, or can be a different person in the environment.

The tracking system can also include motion sensing or any other human motion capture system to track the movement of the person or the feature of the person in the environment. The tracking system can also track an object that is capable of being moved in the environment, such as a chair or other type of object that is movable by a person. In addition to static objects that are cable of being moved, the tracking system can also track an entity that moves dynamically in the environment, such as a person or a dog that may move in any direction at any time in the environment. In addition to skeletal tracking and motion sensing, the tracking system may include an imaging system with a depth sensor and/or a depth camera that captures images of the environment in which the device is located.

The alternate reality device can also implement a detection algorithm that identifies an entity recognized by the tracking system based on identifiable characteristics of the entity. The detection algorithm in the alternate reality device can be implemented as a neural network (e.g., a deep neural network (DNN), a machine learning network, a convolutional neural network (CNN), and the like) to identify the entity in the environment. The detection algorithm can be implemented as a software application in the alternate reality device, and includes entity specific recognizers that distinguish different entities, such as persons, different types of objects, animals, etc. based on identifiable characteristics of the entities. For example, the size and manner of movements of a person can be distinguished from the size and manner of movement of a dog in the environment.

For skeletal tracking by the tracking system, the neural network of the detection algorithm can be used to determine the corresponding skeleton model to use, such as for tracking a dog that would have a different skeleton model than the skeleton model for a person. Similarly, an object such as a chair can be distinguished from a table, a book, or other objects based on inherent characteristics of the objects. The entity specific recognizers may also be referred to as the classifiers of a neural network, where the classifiers distinguish different entities, or portions of different entities. Additionally, the detection algorithm, or at least the neural network features of the detection algorithm, can be implemented in specialized silicon rather than in software for increased speed of entity identification.

The hologram positioning application can also be implemented as a software application in the alternate reality device. The hologram positioning application receives motion data from the tracking system and receives entity characteristic data from the detection algorithm, and can then determine a position and an orientation of an entity in the environment based on the motion data and the entity characteristic data. The hologram positioning application can then generate a hologram that appears associated with the entity as the entity moves in the environment. For a recognized, identified, and tracked object, the hologram positioning application can generate a hologram that appears attached to or placed on the object and remains associated with the object as the object moves in the environment.

For example, the hologram positioning application can generate a hologram of a book that appears, to the person wearing the alternate reality device, to be placed on a chair in the environment, and the hologram of the book remains in the position on the chair if the chair is moved by a person in the environment. Similarly, for a recognized, identified, and tracked feature of a person, such as a hand of the person, the hologram positioning application can generate a hologram that appears attached to or held in the hand of the person, and the hologram remains associated with the feature of the person as the hand moves in the environment. For example, the hologram positioning application can generate a hologram of an item that appears, to the person wearing the alternate reality device, to be carried by the hand of the person in the environment.

In embodiments of augmenting a moveable entity with a hologram, a hologram can be generated and associated with (also referred to as docked) on a moveable and/or moving entity, such as a person, animal, or an object in a 3D environment space. Further, based on entity recognition, identification, and tracking, a hologram that is associated with an entity is generated taking into consideration meaningful aspects of the environment. For example, a hologram of a chess board will be docked to a flat surface in the environment, such as on a table, shelf, or countertop, but not on the ceiling of a room (e.g., the environment). Further, a hologram of a shoe may be associated with a foot of a person (e.g., a feature of the person) rather than with a hand of the person, and a hat is associated with a head of the person.

It should be noted that, in aspects of augmenting a moveable entity with a hologram, the environment itself does not need to be modified to support the alternate reality device capability of determining its own location and orientation in the 3D environment (e.g., in coordinate space). No external markers, cameras, or other hardware is needed, but rather, the alternate reality device can independently determine its own position and motion tracking in the environment. Further, the alternate reality device can wirelessly communicate to correlate the positions of the alternate reality device with another device implemented for virtual reality and/or augmented reality, such as a camera-based input device that a person can hold and move about in the environment.

While features and concepts of augmenting a moveable entity with a hologram can be implemented in any number of different devices, systems, networks, environments, and/or configurations, embodiments of augmenting a moveable entity with a hologram are described in the context of the following example devices, systems, and methods.

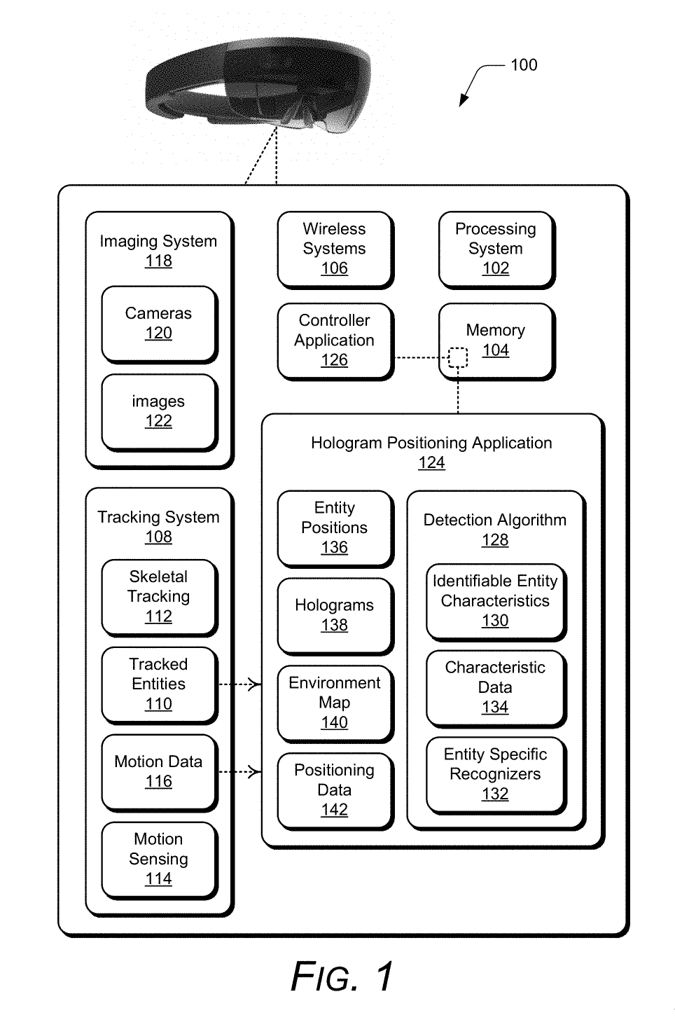

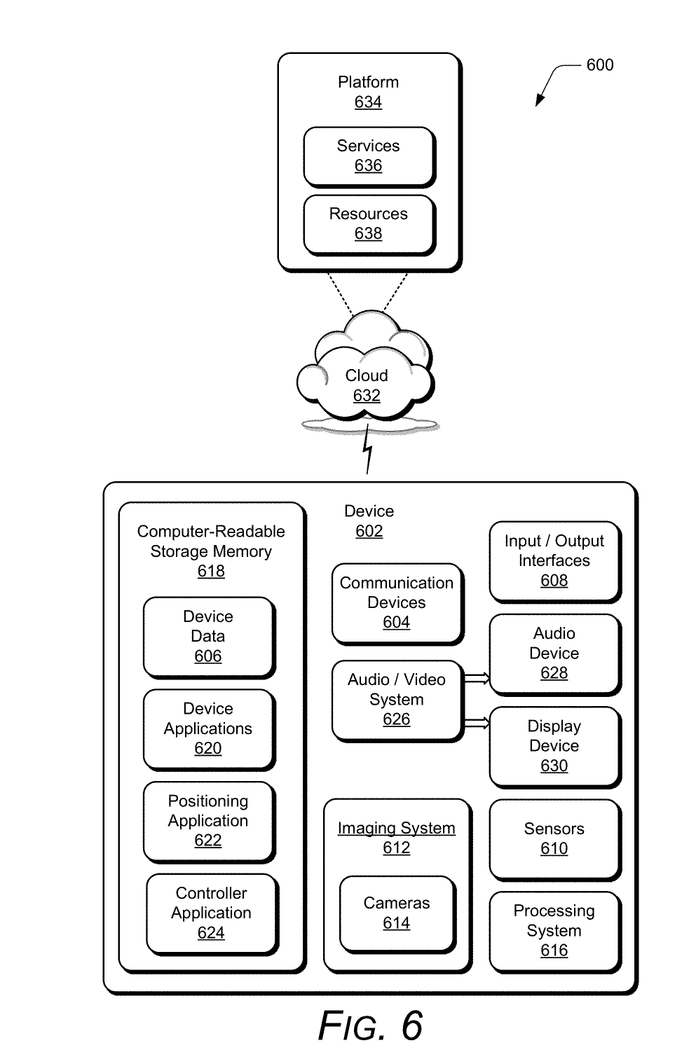

FIG. 1 illustrates an example alternate reality device 100 in which embodiments of augmenting a moveable entity with a hologram can be implemented. The example alternate reality device 100 can be implemented with various components, such as a processing system 102 and memory 104 (e.g., non-volatile, physical memory), and with any number and combination of differing components as further described with reference to the example device shown in FIG. 6. In implementations, the processing system 102 may include multiple and/or different processors, such as a microprocessor, a separate graphics processor, and/or a separate high-speed, dedicated processor for tracking motion of the alternate reality device. Although not shown, the alternate reality device 100 includes a power source, such as a battery, to power the various device components. Further, the alternate reality device 100 is a wireless communication-enabled device and can include different wireless radio systems 106, such as for Wi-Fi, Bluetooth™, Mobile Broadband, LTE, as well as 802.11a/b/g/n/ac network connectivity technologies, and/or any other wireless communication system or format. Generally, the alternate reality device 100 implements one or more wireless communication systems that each include a radio device, antenna, and chipset that is implemented for wireless communication with other devices, networks, and services.

The alternate reality device 100 can include various different types of sensors and systems to implement the features and aspects of augmenting a moveable entity with a hologram in an environment, such as in three-dimensional (3D) indoor or outdoor space. The alternate reality device 100 includes a tracking system 108 that is implemented to recognize an entity 110 and track movement of the entity in the environment. The tracking system 108 can recognize the entity 110 in the environment as a person or features of the person (e.g., an arm, hand, head, etc.), an animal (e.g., a dog or cat), or an object, such as a chair, a table, or other item that may be moved by a person. The tracking system 108 can include skeletal tracking 112 to track the movement of a person or a feature of the person in the environment, where the person or feature of the person, may be the person using the alternate reality device, or can be a different person in the environment.

The tracking system 108 can also include motion sensing 114 or any other human motion capture system to track the movement of the person or the feature of the person in the environment, as motion data 116. The tracking system 108 can also track an object that is capable of being moved in the environment, such as a chair or other type of object that is movable by a person. In addition to static objects that are cable of being moved, the tracking system 108 can also track an entity that moves dynamically in the environment, such as a person or a dog that may move in any direction at any time in the environment. In embodiments, the tracking system 108 may be implemented with the motion capture technology of the KINECT system from Microsoft for human motion capture. Generally, the tracking system can be implemented as a sensors and motion sensing device with a natural user interface for detecting gestures and voiced commands for hands-free control of other devices, such as implemented for 3D motion capture, facial recognition, and voice recognition.

In addition to the skeletal tracking 112 and the motion sensing 114, the tracking system 108 may include an imaging system 118 with an infra-red projector, a depth sensor, and/or a depth camera (or cameras) that captures images of the environment in which the device is located. The imaging system 118 of the alternate reality device 100 has one or more cameras 120 that capture images 122 of the environment in which the alternate reality device is being used. In implementations, the cameras 120 can be visual light cameras, such as high-speed monochromatic or black-and-white cameras that capture the images 122 in the 3D environment. Alternatively, a single camera 116 can be implemented with simultaneous localization and mapping (SLAM) for the 3D imaging of the environment, to initially recognize entities in the environment, and then track the entities 110.

The alternate reality device 100 includes a hologram positioning application 124 and a controller application 126. The hologram positioning application 124 can be implemented with a detection algorithm 128, and the applications can be implemented as software applications or modules, such as computer-executable software instructions that are executable with the processing system 102 to implement embodiments of augmenting a moveable entity with a hologram. As indicated, the hologram positioning application 124 and/or the controller application 126 can be stored on computer-readable storage memory (e.g., the memory 104), such as any suitable memory device or electronic data storage implemented in the input device. Further, although the hologram positioning application 124 and the controller application 126 are shown as separate software applications or modules, the hologram positioning application and the controller application may be implemented together and/or integrated with an operating system of the input device. Further, although the detection algorithm 128 is shown and described as a component or module of the hologram positioning application 124, the detection algorithm 128 may be implemented independently of the hologram positioning application.

In embodiments, the detection algorithm 128 can identify an entity recognized by the tracking system 108 (e.g., a tracked entity 110) based on identifiable characteristics 130 of the entity. The detection algorithm 128 in the alternate reality device 100 can be implemented as a neural network (e.g., a deep neural network (DNN), a machine learning network, a convolutional neural network (CNN), and the like) to identify the entity in the environment. The detection algorithm 128 can be implemented as a software application in the alternate reality device, and includes entity specific recognizers 132 that distinguish different entities, such as persons, different types of objects, animals, etc. based on the identifiable characteristics 130 of the entities, and the entity specific recognizers 132 generate the characteristic data 134 for a particular entity. For example, the size and manner of movements of a person can be distinguished from the size and manner of movement of a dog in the environment. Other identifiable entity characteristics 130 and the characteristic data 134 may include distinguishing features of an entity, such as the dimensions of an object to be augmented with a hologram that appears realistic to a user of the alternate reality device.

For the skeletal tracking 112 by the tracking system 108, a neural network of the detection algorithm can be used to determine the corresponding skeleton model to use, such as for tracking a dog that would have a different skeleton model than the skeleton model for a person. Similarly, an object such as a chair can be distinguished from a table, a book, or other objects based on inherent characteristics of the objects. The entity specific recognizers 132 may also be referred to as the classifiers of a neural network, where the classifiers distinguish different entities, or portions of different entities. Additionally, the detection algorithm 124, or at least the neural network features of the detection algorithm, can be implemented in specialized silicon rather than in software for increased speed of entity identification.

Generally, a neural network, or a convolutional neural network, implemented as the detection algorithm 124 can be used for computer vision tasks, such as for object detection, entity detection, and scene recognition. A convolutional neural network is a machine learning computer algorithm implemented for self-learning with multiple layers, also referred to as neural layers or the classifiers, that run logistic regression on data to learn features and train parameters of the network. The multiple classifier layers can initially recognize edges, lines, and densities of abstract features, and progress to identifying object and entity parts formed by the abstract features from the edges, lines, and densities. As the self-learning and training progresses through the many neural layers, a convolutional neural network can begin to detect objects and scenes, such as for object classification and scene recognition.

In embodiments, the hologram positioning application 124 is implemented to receive the tracked entities 110 and the motion data 116 from the tracking system 108, and receive the entity characteristic data 134 from the detection algorithm 128. The hologram positioning application 124 can then determine a entity position 136 of an entity in the environment based on the motion data 116 and the entity characteristic data 134. The hologram positioning application 124 can then generate a hologram 138 that appears associated with the entity as the entity moves in the environment. For a recognized, identified, and tracked object, the hologram positioning application 124 can generate a hologram 138 that appears attached to or placed on the object and remains associated with the object as the object moves in the environment.

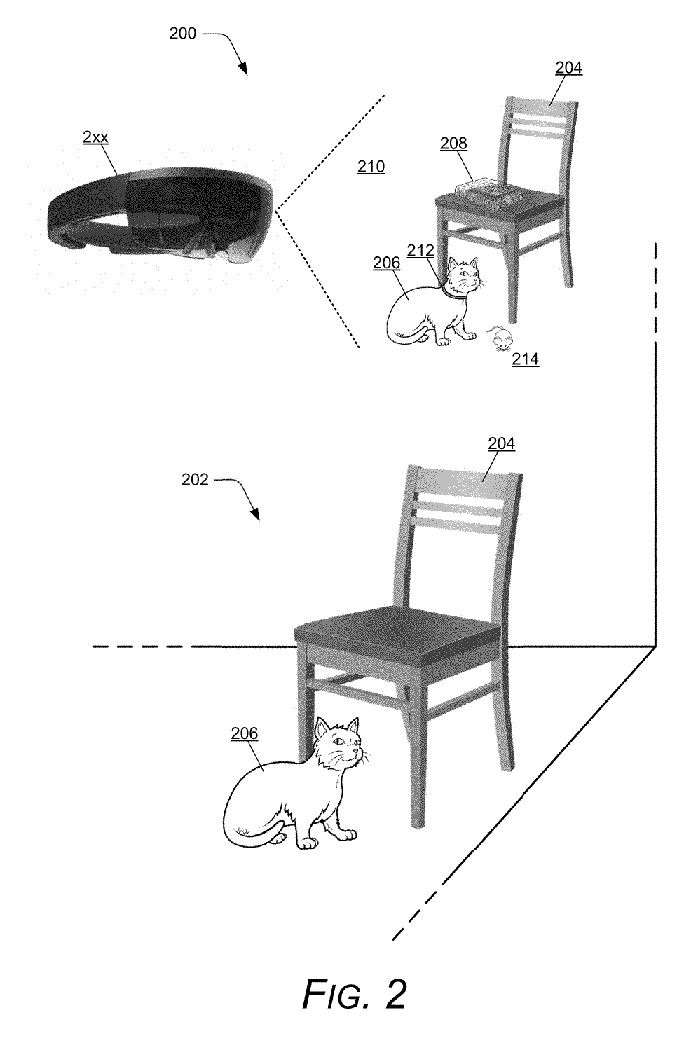

For example, the hologram positioning application 124 can generate a hologram 138 of a book that appears, to the person wearing the alternate reality device 100, to be placed on a chair in the environment, and the hologram of the book remains in the position on the chair if the chair is moved by a person in the environment. Other examples are shown and described with reference to FIG. 2. Similarly, for a recognized, identified, and tracked feature of a person, such as a hand of the person, the hologram positioning application 124 can generate a hologram 138 that appears attached to or held in the hand of the person, and the hologram remains associated with the feature of the person as the hand moves in the environment. For example, the hologram positioning application 124 can generate a hologram 138 of an item that appears, to the person wearing the alternate reality device 100, to be carried by the hand of the person in the environment. The hologram positioning application 124 can also perform depth mapping of a feature of a person (e.g., an arm, hand, or head of the person) to determine the proper size of a hologram to be associated on the person. Holograms can include a wearable article like a gauntlet, shield, glove, hat etc., or may also be augmenting visuals that provide information about the person when properly positioned based on the movement and outer bounds of the person.

Further, the hologram positioning application 124 can generate an environment map 140 of the environment with prediction and mapping algorithms, such as based on feature points and descriptors extracted from the images 122 of the environment and utilizing image patch matching techniques to correlate the alternate reality device positions and the entity positions 136 in the environment. As noted above, the environment itself does not need to be modified to support the alternate reality device 100 capability of determining its own location and orientation in the 3D environment (e.g., in coordinate space). No external markers, cameras, or other hardware is needed, but rather, the alternate reality device 100 can independently determine its own position and motion tracking in the environment. This is also commonly referred to as “inside out” tracking, performed by the device itself by using the imaging system 118 and the tracking system 108 that are implemented in the device.

Additionally, the hologram positioning application 124 can utilize other positioning data 142 (e.g., for orientation, velocity, acceleration, etc.) and/or communicate the positioning data 142 to another device. The hologram positioning application 124 can correlate the device positions 132 of the alternate reality device 100 with another device implemented for virtual reality and/or augmented reality, such as a hand-held camera-based input device implemented for use in an alternate reality system. Generally, the term “alternate reality” is used herein to refer to devices and systems that are implemented for virtual reality and/or augmented reality, such as for mixed reality devices. For example, an augmented reality device may be implemented with the ability to block out visual pixels and operate as a virtual reality device, or a virtual reality device may be implemented with a pass-through camera through the display to mix reality with virtual objects, such as in an augmented reality device.

FIG. 2 illustrates an example 200 of augmenting a moveable entity with a hologram. As described herein, the alternate reality device 100 that is shown and described with reference to FIG. 1 can be worn by a person to immerse him or herself in a virtual and/or augmented reality environment. In this example 200, an environment 202 (e.g., a room) includes two recognized (by the tracking system 108), identified (by the detection algorithm 128), and tracked entities, such as a chair 204 and a cat 206. The hologram positioning application 124 can generate a hologram 138 of a book 208 that appears in the alternate reality view 210, to the person wearing the alternate reality device 100, to be placed on the chair 204 in the environment 202, and the hologram of the book 208 remains in the position on the chair 204 if the chair is moved by a person in the environment.

Similarly, the hologram positioning application 124 can generate a hologram 138 of a collar 212 that appears in the alternate reality view 210, to the person wearing the alternate reality device 100, to be attached to the cat 206 in the environment 202, and the hologram of the collar 212 remains associated on the cat as the cat moves in the environment. In another example, the hologram positioning application 124 can generate a hologram 138 of a mouse 214 that appears in the alternate reality view 210, to the person wearing the alternate reality device 100, to be proximate the cat 206 in the environment 202, and the hologram of the mouse 214 remains associated with the cat at an approximate offset as the cat moves in the environment. Note that a hologram 138 may appear to be placed on, attached to, or proximate an entity (e.g., an object, a person, or a feature of the person) in the alternate reality view 210. Additionally, an entity may have one or more holograms that are associated with the entity as the entity moves or is moved in the environment 202. For example, the cat 206 has two associated holograms in this example.

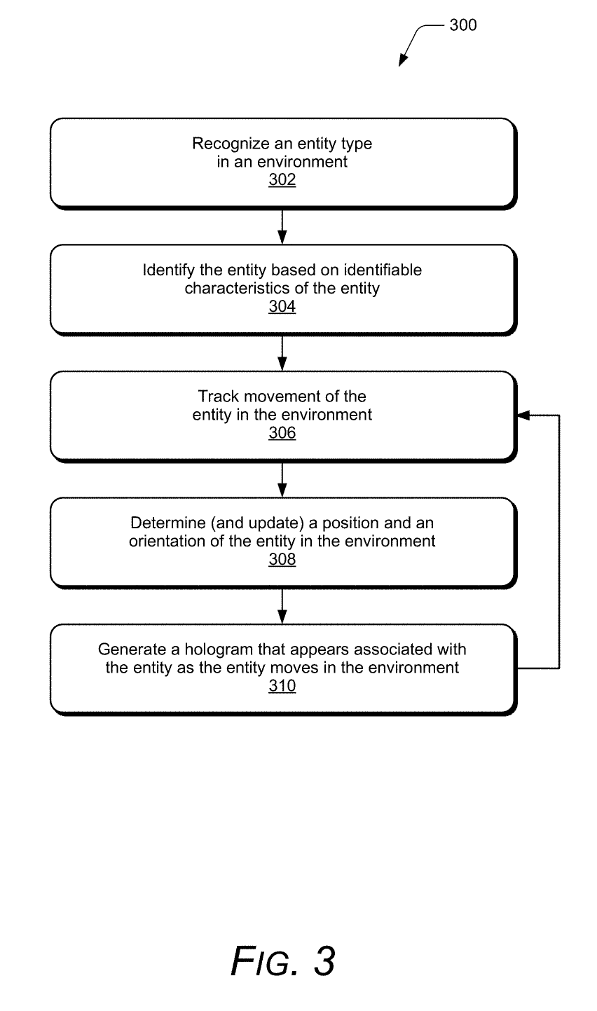

Example method 300 is described with reference to FIG. 3 in accordance with one or more embodiments of augmenting a moveable entity with a hologram. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates an example method 300 of augmenting a moveable entity with a hologram, and is generally described with reference to the alternate reality device in an environment. The order in which the method is described is not intended to be construed as a limitation, and any number or combination of the method operations can be performed in any order to implement a method, or an alternate method.

At 302, an entity type is recognized in an environment. For example, the tracking system 108 that is implemented in the alternate reality device 100 recognizes a type of an entity 110 in an environment, such as in three-dimensional (3D) space, and the movement of the entity is tracked in the 3D space. In another example, the tracking system 108 in the alternate reality device 100 recognizes the two entities (e.g., identified as the chair 204 and the cat 206 in FIG. 2) in the environment 202. Entity types can be recognized, or determined, in a first pass view of the environment, followed by entity-specific recognition with the detection algorithm.

At 304, the entity is identified based on identifiable characteristics of the entity. For example, the detection algorithm 128 that is implemented in the alternate reality device 100 identifies the entity 110 based on the identifiable characteristics 130 of the entity. The detection algorithm 128 is implemented to include the entity specific recognizers 132 that are trained to identify and distinguish the entities. For example, the entity specific recognizers 132 can identify that the two entities in the environment 202 in FIG. 2 are the chair 204 and the cat 206.

At 306, movement of the entity is tracked in the environment. For example, the tracking system 108 that is implemented in the alternate reality device 100 tracks the movement of the entity 110 in an environment. As noted above, the tracked entity 110 may be a feature of a person, and the tracking system 108 includes the skeletal tracking 112 of the feature of the person moving in the environment and/or the tracking system 108 includes the motion sensing 114 of the feature of the person moving in the environment. In another example, the tracked entity 110 may be an object, such as the chair 204, that is capable of moving in the environment 202, or the tracked entity 110 may be a dynamically moving entity, such as the cat 206, that may move in any direction at any time in the environment.

At 308, a position and an orientation of the entity in the environment is determined (and updated). For example, the hologram positioning application 124 that is implemented in the alternate reality device 100 determines (and updates) the entity position 136 in the environment based the on the motion data 116 received from the tracking system 108, where the motion data corresponds to tracking the movement of the entity in the environment. Accordingly, the hologram positioning application 124 can map a depth of the tracked entity 110 in the environment along with updating the entity position. Additionally, the hologram positioning application 124 determines (and updates) the entity position 136 in the environment based on the entity characteristic data 134 received from the detection algorithm 128, and/or based on the depth mapping of the entity in the environment.

At 310, a hologram is generated that appears associated with the entity as the entity moves in the environment. For example, the hologram positioning application 124 that is implemented in the alternate reality device 100 generates the hologram 138 that appears associated with the entity as the entity moves in the environment. The hologram 138 can appear as a wearable item being worn by a person, and/or the hologram can appear attached to, placed on, or proximate the entity (e.g., the object, person, or feature of the person) and remains associated with the object as the object moves in the environment. In another example, the hologram positioning application 124 generates a hologram of the book 208 that appears in the alternate reality view 210, to the person wearing the alternate reality device 100, to be placed on the chair 204 in the environment 202, and the hologram of the book 208 remains in the position on the chair 204 if the chair is moved by a person in the environment. Similarly, the hologram positioning application 124 generates a hologram of the collar 212 that appears in the alternate reality view 210, to the person wearing the alternate reality device 100, to be attached to the cat 206 in the environment 202, and the hologram of the collar 212 remains associated on the cat as the cat moves in the environment. Optionally, the method continues at 306 to continue tracking the movement of an entity in the environment.

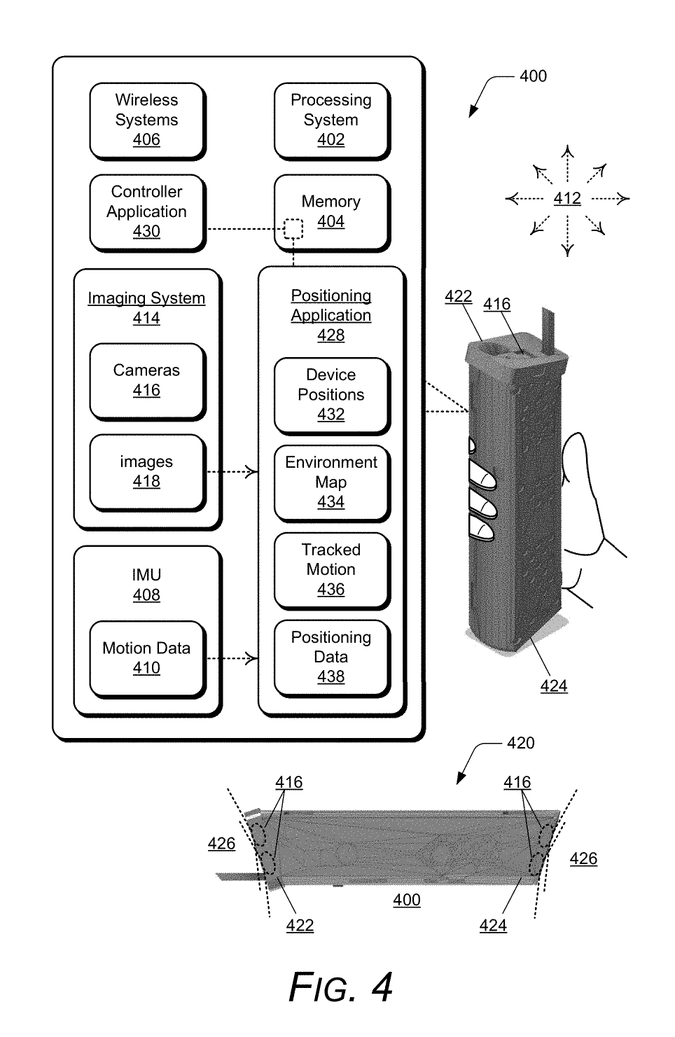

FIG. 4 illustrates an example of a camera-based input device 400 in which embodiments of augmenting a moveable entity with a hologram can be implemented. The example input device 400 can be implemented with various components, such as a processing system 402 and memory 404 (e.g., non-volatile, physical memory), and with any number and combination of differing components as further described with reference to the example device shown in FIG. 6. In implementations, the processing system 402 may include multiple and/or different processors, such as a microprocessor, a separate graphics processor, and/or a separate high-speed, dedicated processor for tracking motion of the input device. Although not shown, the input device 400 includes a power source, such as a battery, to power the various device components. Further, the input device 400 is a wireless communication-enabled device and can include different wireless radio systems 406, such as for Wi-Fi, Bluetooth™, Mobile Broadband, LTE, as well as 802.11a/b/g/n/ac network connectivity technologies, and/or any other wireless communication system or format. Generally, the input device 400 implements one or more wireless communication systems that each include a radio device, antenna, and chipset that is implemented for wireless communication with other devices, networks, and services.

The input device 400 can include various different types of sensors, such as an inertial measurement unit 408 implemented as a motion sensor in this example input device. The inertial measurement unit 408 can collect motion data 410 associated with the velocity and acceleration of the input device 400 in an environment 412, such as in three-dimensional (3D) indoor or outdoor space. Generally, the inertial measurement unit can include an accelerometer and gyroscope to detect changes in position, angular velocity, and linear acceleration of the input device 400 as a user manipulates and moves the device. Although generally described as a handheld device that is moved around when held by a user, the input device 400 may be attached to any moving device or item, such as a remotely controlled vehicle or robot for use as an external tracking system, or the input device 400 may be positioned in a static location in the environment.

The input device 400 has an imaging system 414 with cameras 416 that capture images 418 of the environment 412 in which the input device is positioned. In implementations, the cameras 416 are two (or more) visual light cameras, such as high-speed monochromatic or black-and-white cameras that capture the images 418 in the 3D environment. Alternatively, a single camera 416 can be implemented with simultaneous localization and mapping (SLAM) for the 3D imaging of the environment. In implementations, the cameras 416 are visual light cameras that capture the images 418 of the environment 412 without the need for emitted and/or reflected light, such as with infra-red (IR) and other types of cameras that image by detecting reflected light. The cameras 416 can be integrated at various positions in a housing of the input device 400, such as at opposing ends of the input device. Generally, the cameras 416 are positioned in the input device for a maximum field of view of the environment, such as for maximum visibility of the environment providing the best opportunity to image visual points in the environment for device tracking. This is generally illustrated at 420 where a first end 422 of the input device 400 includes two of the cameras 416, and a second end 424 of the input device includes an additional two of the cameras 416. The cameras 416 are positioned in the input device 400 to cover a large field-of-view 426 to facilitate tracking the motion of the input device in the environment, based on the orientation and position of the input device in 3D space.

The cameras 416 are merely shown at 420 for general discussion of the implementation in the input device 400, and in practice, may be smaller (e.g., approximately one centimeter square) and integrated in a housing of the input device in various configurations. Further, although the input device 400 is generally described and shown as having four of the visible light cameras 416, the input device may be implemented with any number of cameras (e.g., two cameras) positioned on any number of sides and/or ends of the input device to cover by field-of-view as much of the visible area of the environment 412 as can be imaged. Further, a pair (or more than one pair) of the visual light cameras can be implemented in the imaging system 414 to operate as a stereo camera for 3D imaging in the 3D environment.

The input device 400 includes a positioning application 428 and a controller application 430, and the applications can be implemented as software applications or modules, such as computer-executable software instructions that are executable with the processing system 402 to implement embodiments of augmenting a moveable entity with a hologram. As indicated, the positioning application 428 and/or the controller application 430 can be stored on computer-readable storage memory (e.g., the memory 404), such as any suitable memory device or electronic data storage implemented in the input device. Further, although the positioning application 428 and the controller application 430 are shown as separate software applications or modules, the positioning application and the controller application may be implemented together and/or integrated with an operating system of the input device.

In embodiments, the positioning application 428 is implemented to receive the motion data 410 from the inertial measurement unit 408 and receive the images 418 of the environment 412 from the visual light cameras 416. The positioning application 428 can then determine device positions 432 of the input device 400 based on both the motion data 410 and the images 418 correlated with a map 434 of the environment. The positioning application 428 can then track the motion 436 of the input device in the 3D environment 412 based on the determined device positions 432 of the input device. The positioning application 428 can be implemented with algorithms, such as a prediction algorithm to predict device positions and a simultaneous localization and mapping (SLAM) algorithm for motion tracking of the input device 400 in the 3D environment 412. The prediction algorithm can be utilized to predict forward positions of the input device 400 based on the current motion of the device and based on motion models of what is reasonable for motion of the input device 400 in the environment, such as when held and moved by a user.

Further, the positioning application 428 can generate the map 434 of the environment 412 with the prediction and mapping algorithms, such as based on feature points and descriptors extracted from the images 418 of the environment and utilizing image patch matching techniques to correlate the input device positions 432 in the environment. As noted above, the environment itself does not need to be modified to support the input device 400 capability of determining its own location and orientation in the 3D environment 412 (e.g., in coordinate space). No external markers, cameras, or other hardware is needed, but rather, the input device 400 can independently determine its own position and motion tracking in the environment. This is also commonly referred to as “inside out” tracking, performed by the device itself by using the cameras 416 and sensors (e.g., the inertial measurement unit 408) that are implemented in the device.

Additionally, the positioning application 428 can utilize other positioning data 438 (e.g., for orientation, velocity, acceleration, etc.) and/or communicate the positioning data 438 to another device. The positioning application 428 can correlate the device positions 432 of the input device 400 with another device implemented for virtual reality and/or augmented reality, such as the alternate reality device 100 (e.g., a head-mounted display unit) that a person can wear to immerse him or herself in an alternate reality environment. In implementations, the input device 400 can include a user-selectable input, such as a push-button or other type of input activation, effective to initiate a control input being communicated to a mixed reality device. As noted above, a wireless radio system 406 of the input device 400 can be used to wirelessly connect the input device 400 to a communication-enabled device via a wireless network, and a user of the input device 400 can initiate control of features that may be displayed in the alternate reality device 100 worn by the user, or worn by another user.

In implementations, the controller application 430 can be designed to receive the motion data 410 from the inertial measurement unit 408 and determine that the input device is moving or not moving based on the motion data. The controller application 430 can then power-off the imaging system 414 that includes the cameras 416 if the input device 400 is determined not to be moving (and the imaging system is currently powered on). Alternatively, the controller application 430 can power-on the imaging system 414 of the input device if the input device is determined to be moving (and the imaging system is currently powered off).

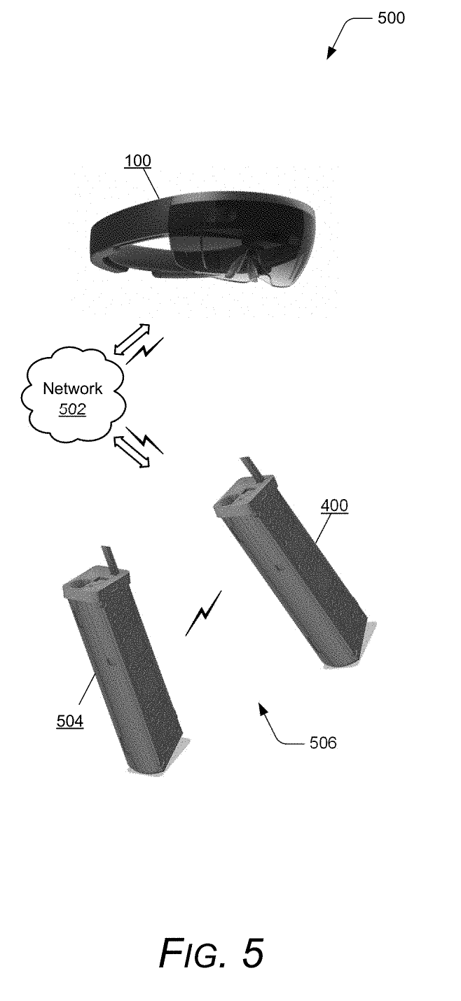

FIG. 5 illustrates an example system 500 in which embodiments of augmenting a moveable entity with a hologram can be implemented. As described herein, the camera-based input device 400 that is shown and described with reference to FIG. 4 can be utilized as an input device to control another communication-enabled device via a network 502, and/or to enhance a virtual reality and/or augmented reality immersive environment for a user. Any of the devices described herein can communicate via the network 502, such as for video and data communication between the input device 100 and the alternate reality device 100. The network can be implemented to include a wired and/or a wireless network. The network 502 can also be implemented using any type of network topology and/or communication protocol, and can be represented or otherwise implemented as a combination of two or more networks, to include IP based networks and/or the Internet. The network may also include mobile operator networks that are managed by a mobile network operator and/or other network operators, such as a communication service provider, mobile phone provider, and/or Internet service provider.

In implementations, the camera-based input device 400 can wirelessly communicate, such as via Wi-Fi and Bluetooth™ with the alternate reality device 100, which may be any type of viewing device for virtual reality and/or augmented reality, or may be virtual reality glasses, augmented reality glasses, a mobile device with an integrated display, and/or a display device coupled to a computing device. Additionally, a network connection may be established between multiple devices, such as the input device 400 is wirelessly connected to another input device 504, as shown at 506. Further, multiple input devices 400, 504 (or more) can be utilized with one alternate reality device 100 (e.g., a head-mounted display unit), or similarly, one input device 400 may be used in a virtual or augmented reality system with multiple head-mounted display units for several users.

In another example implementation, the tracking motion 436 of the input device 400 by the positioning application 428 can be used to create a network connection between two devices, such as a user motion of the input device 400 that represents a connection between the devices, and the network connection is established. For example, the user motion of the input device 400 can be detected as a gesture command for a printer device to print image files stored on a Wi-Fi linked camera, where the devices are all communicating on the same network 502. These features can be implemented with the precise motion tracking that is enabled with the techniques for augmenting a moveable entity with a hologram, as described herein.

FIG. 6 illustrates an example system 600 that includes an example device 602, which can implement embodiments of augmenting a moveable entity with a hologram. The example device 602 can be implemented as any of the computing devices, user devices, and server devices described with reference to the previous FIGS. 1-5, such as any type of mobile device, wearable device, client device, mobile phone, tablet, computing, communication, entertainment, gaming, media playback, and/or other type of device. For example, the input devices and wearable devices described herein may be implemented as the example device 602 or with various components of the example device.

The device 602 includes communication devices 604 that enable wired and/or wireless communication of device data 606, such as sensor data, images captured by the cameras, and positioning data associated with one or more of the devices. Additionally, the device data can include any type of audio, video, and/or image data. The communication devices 604 can also include transceivers for cellular phone communication and for network data communication.

The device 602 also includes input/output (I/O) interfaces 608, such as data network interfaces that provide connection and/or communication links between the device, data networks, and other devices described herein. The I/O interfaces can be used to couple the device to any type of components, peripherals, and/or accessory devices. The I/O interfaces also include data input ports via which any type of data, media content, and/or inputs can be received, such as user inputs to the device, as well as any type of audio, video, and/or image data received from any content and/or data source. The device 602 includes any type of sensors 610 (e.g., motion sensors), such as the inertial measurement unit 408 implemented in the input device 400. The device 602 also includes an imaging system 612 that includes cameras 614 used to capture images. Examples of the imaging system 612 and the cameras 614 include the imaging system 414 and the visual light cameras 416 implemented in the input device 400, as described with reference to FIG. 4.

The device 602 includes a processing system 616 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 602 may further include any type of a system bus or other data and command transfer system that couples the various components within the device. A system bus can include any one or combination of different bus structures and architectures, as well as control and data lines.

The device 602 also includes a computer-readable storage memory 618, such as data storage devices that can be accessed by a computing device, and that provide persistent storage of data and executable instructions (e.g., software applications, programs, functions, and the like). Examples of the computer-readable storage memory 618 include volatile memory and non-volatile memory, fixed and removable media devices, and any suitable memory device or electronic data storage that maintains data for computing device access. The computer-readable storage memory can include various implementations of random access memory (RAM) (e.g., the DRAM and battery-backed RAM), read-only memory (ROM), flash memory, and other types of storage media in various memory device configurations.

The computer-readable storage memory 618 provides storage of the device data 606 and various device applications 620, such as an operating system that is maintained as a software application with the computer-readable storage memory and executed by the processing system 616. In this example, the device applications include a positioning application 622 and a controller application 624 that implement embodiments of augmenting a moveable entity with a hologram, such as when the example device 602 is implemented as the alternate reality device 100 and/or as the input device 400 described herein with reference to FIGS. 1-5. Examples of the positioning application 622 and the controller application 624 include the positioning application 428 and the controller application 430 implemented in the input device 400, as described with reference to FIG. 4. Further, an example of the positioning application 622 includes the hologram positioning application 124 implemented in the alternate reality device 100, as described with reference to FIGS. 1-3.

The device 602 also includes an audio and/or video system 626 that generates audio data for an audio device 628 and/or generates display data for a display device 630. The audio device and/or the display device include any devices that process, display, and/or otherwise render audio, video, display, and/or image data. In implementations, the audio device and/or the display device are integrated components of the example device 602. Alternatively, the audio device and/or the display device are external, peripheral components to the example device.

In embodiments, at least part of the techniques described for augmenting a moveable entity with a hologram may be implemented in a distributed system, such as over a “cloud” 632 in a platform 634. The cloud 632 includes and/or is representative of the platform 634 for services 636 and/or resources 638. The platform 634 abstracts underlying functionality of hardware, such as server devices (e.g., included in the services 636) and/or software resources (e.g., included as the resources 638), and connects the example device 602 with other devices, servers, etc. The resources 638 may also include applications and/or data that can be utilized while computer processing is executed on servers that are remote from the example device 602. Additionally, the services 636 and/or the resources 638 may facilitate subscriber network services, such as over the Internet, a cellular network, or Wi-Fi network. The platform 634 may also serve to abstract and scale resources to service a demand for the resources 638 that are implemented via the platform, such as in an interconnected device embodiment with functionality distributed throughout the system 600. For example, the functionality may be implemented in part at the example device 602 as well as via the platform 634 that abstracts the functionality of the cloud.

Although embodiments of augmenting a moveable entity with a hologram have been described in language specific to features and/or methods, the appended claims are not necessarily limited to the specific features or methods described. Rather, the specific features and methods are disclosed as example implementations of augmenting a moveable entity with a hologram, and other equivalent features and methods are intended to be within the scope of the appended claims. Further, various different embodiments are described and it is to be appreciated that each described embodiment can be implemented independently or in connection with one or more other described embodiments. Additional aspects of the techniques, features, and/or methods discussed herein relate to one or more of the following embodiments.

An alternate reality device implemented for augmenting an entity with a hologram, the alternate reality device comprising: a tracking system configured to recognize the entity in an environment and track movement of the entity in the environment; a detection algorithm configured to identify the entity based on identifiable characteristics of the entity; a memory and processor system configured to execute a hologram positioning application that is implemented to: receive motion data from the tracking system; receive entity characteristic data from the detection algorithm; determine a position and an orientation of the entity in the environment based on the motion data and the entity characteristic data; and generate the hologram that appears associated with the entity as the entity moves in the environment.

Alternatively or in addition to the above described alternate reality device, any one or combination of: the entity being tracked is a feature of a person; and the tracking system comprises skeletal tracking configured to track the movement of the feature of the person in the environment based on the skeletal tracking. The person is one of the person using the alternate reality device or a different person in the environment. The entity being tracked is a feature of a person; and the tracking system comprises motion sensing configured to track the movement of the feature of the person in the environment based on the motion sensing. The entity being tracked is a feature of a person; and the hologram appears as a wearable item being worn by the person. The entity being tracked is an object capable of being moved in the environment; and the hologram appears attached to or placed on the object and remains associated with the object as the object moves in the environment. The entity being tracked moves dynamically in the environment; and the hologram appears attached to or placed on the entity and remains associated with the entity as the entity moves in the environment. The detection algorithm comprises a neural network configured to identify the entity in the environment, the neural network including an entity specific recognizer based on the identifiable characteristics of the entity. The environment is in three-dimensional (3D) space; and the hologram positioning application is configured to map a depth of the entity in the environment.

A method for augmenting an entity with a hologram in an environment, the method comprising: recognizing the entity in the environment; tracking movement of the entity in the environment; determining a position of the entity in the environment based on motion data corresponding to said tracking the movement of the entity in the environment; and generating the hologram that appears associated with the entity as the entity moves in the environment.

Alternatively or in addition to the above described method, any one or combination of: Identifying the entity based on identifiable characteristics of the entity utilizing a detection algorithm, including an entity specific recognizer trained to identify the entity. Mapping a depth of the entity in the environment; and wherein the environment is in three-dimensional (3D) space, and said tracking the movement of the entity in the 3D space. The entity is a feature of a person; and said tracking the movement comprises skeletal tracking of the feature of the person in the environment. The entity is a feature of a person; and said tracking the movement comprises motion sensing of the feature of the person in the environment. The entity being tracked is a feature of a person; and the hologram appears as a wearable item being worn by the person. The entity being tracked is an object capable of moving in the environment; and the hologram appears attached to or placed on the object and remains associated with the object as the object moves in the environment.

A head-mounted display unit implemented for augmenting an entity with a hologram, the head mounted display device comprising: a tracking system configured to: recognize the entity in an environment; and track movement of the entity in the environment. A memory and processor system configured to execute a hologram positioning application that is implemented to: receive motion data from the tracking system; determine a position of the entity in the environment based on the motion data; and generate the hologram that appears associated with the entity as the entity moves in the environment.

Alternatively or in addition to the above described method, any one or combination of: the memory and processor system are configured to execute a detection algorithm that is implemented to identify the entity based on identifiable characteristics of the entity. The entity is a feature of a person; and the tracking system is configured to said track the movement of the entity in the environment based on at least one of skeletal tracking and motion sensing of the feature of the person in the environment. The entity being tracked is an object capable of being moved in the environment; and the hologram appears attached to or placed on the object and remains associated with the object as the object moves in the environment.

1. An alternate reality device implemented for augmenting an entity with a hologram, the alternate reality device comprising:
a tracking system configured to recognize the entity in an environment and track movement of the entity in the environment;
a detection algorithm configured to identify the entity based on identifiable characteristics of the entity;
a memory and processor system configured to execute a hologram positioning application that is implemented to:
receive motion data from the tracking system;
receive entity characteristic data from the detection algorithm;
determine a position and an orientation of the entity in the environment based on the motion data and the entity characteristic data; and
generate the hologram that appears associated with the entity as the entity moves in the environment.

2. The alternate reality device as recited in claim 1, wherein:
the entity being tracked is a feature of a person; and
the tracking system comprises skeletal tracking configured to track the movement of the feature of the person in the environment based on the skeletal tracking.

3. The alternate reality device as recited in claim 2, wherein the person is one of the person using the alternate reality device or a different person in the environment.

4. The alternate reality device as recited in claim 1, wherein:
the entity being tracked is a feature of a person; and
the tracking system comprises motion sensing configured to track the movement of the feature of the person in the environment based on the motion sensing.

5. The alternate reality device as recited in claim 1, wherein:
the entity being tracked is a feature of a person; and
the hologram appears as a wearable item being worn by the person.

6. The alternate reality device as recited in claim 1, wherein:
the entity being tracked is an object capable of being moved in the environment; and
the hologram appears attached to or placed on the object and remains associated with the object as the object moves in the environment.

7. The alternate reality device as recited in claim 1, wherein:
the entity being tracked moves dynamically in the environment; and
the hologram appears attached to or placed on the entity and remains associated with the entity as the entity moves in the environment.

8. The alternate reality device as recited in claim 1, wherein:
the detection algorithm comprises a neural network configured to identify the entity in the environment, the neural network including an entity specific recognizer based on the identifiable characteristics of the entity.

9. The alternate reality device as recited in claim 1, wherein:
the environment is in three-dimensional (3D) space; and
the hologram positioning application is configured to map a depth of the entity in the environment.

10. A method for augmenting an entity with a hologram in an environment, the method comprising:
recognizing the entity in the environment;
tracking movement of the entity in the environment;
determining a position and an orientation of the entity in the environment based on motion data corresponding to said tracking the movement of the entity in the environment; and
generating the hologram that appears associated with the entity as the entity moves in the environment.

11. The method as recited in claim 10, further comprising identifying the entity based on identifiable characteristics of the entity utilizing a detection algorithm, including an entity specific recognizer trained to identify the entity.

12. The method as recited in claim 10, further comprising:
mapping a depth of the entity in the environment; and
wherein the environment is in three-dimensional (3D) space, and said tracking the movement of the entity in the 3D space.

13. The method as recited in claim 10, wherein:
the entity is a feature of a person; and
said tracking the movement comprises skeletal tracking of the feature of the person in the environment.

14. The method as recited in claim 10, wherein:
the entity is a feature of a person; and
said tracking the movement comprises motion sensing of the feature of the person in the environment.

15. The method as recited in claim 10, wherein:
the entity being tracked is a feature of a person; and
the hologram appears as a wearable item being worn by the person.

16. The method as recited in claim 10, wherein:
the entity being tracked is an object capable of moving in the environment; and
the hologram appears attached to or placed on the object and remains associated with the object as the object moves in the environment.

17. A head-mounted display unit implemented for augmenting an entity with a hologram, the head mounted display device comprising:
a tracking system configured to:
recognize the entity in an environment; and
track movement of the entity in the environment;
a memory and processor system configured to execute a hologram positioning application that is implemented to:
receive motion data from the tracking system;
determine a position of the entity in the environment based on the motion data; and
generate the hologram that appears associated with the entity as the entity moves in the environment.

18. The head-mounted display unit as recited in claim 17, wherein the memory and processor system are configured to execute a detection algorithm that is implemented to identify the entity based on identifiable characteristics of the entity.

19. The head-mounted display unit as recited in claim 17, wherein:
the entity is a feature of a person; and
the tracking system is configured to said track the movement of the entity in the environment based on at least one of skeletal tracking and motion sensing of the feature of the person in the environment.

20. The head-mounted display unit as recited in claim 17, wherein:
the entity being tracked is an object capable of being moved in the environment; and
the hologram appears attached to or placed on the object and remains associated with the object as the object moves in the environment.
